(19) United States
(12) Patent Application Publication
(10) Pub. No.: US 2019/0104573 A1
(43) Pub. Date: Apr. 4, 2019

(54) INDICATOR AND INDUCTION HEATING DEVICE COMPRISING THE SAME

(71) Applicant: LG Electronics Inc., Seoul (KR)

(72) Inventors: Hyunwook MOON, Seoul (KR); Yangkyeong KIM, Seoul (KR); Eui Sung KIM, Seoul (KR)

(21) Appl. No.: 16/145,278

(22) Filed: Sep. 28, 2018

(30) Foreign Application Priority Data
Sep. 29, 2017 (KR) 10-2017-0128284

(51) Int. Cl. H05B 6/12; H05B 6/06; H05B 6/36

(52) U.S. Cl. CPC H05B 6/1218; H05B 6/36; H05B 6/062

(57) ABSTRACT

An indicator for an induction heating device including a working coil, the indicator that includes: a magnetic flux sensing coil that is configured to (i) sense magnetic flux generated in a state in which the working coil is driven and (ii) convert the sensed magnetic flux into current; a rectifying portion that is configured to rectify current converted by the magnetic flux sensing coil; and a light emitting module that is configured to emit light based on current rectified by the rectifying portion is disclosed.

### CROSS-REFERENCE TO RELATED APPLICATION

This application claims priority to and the benefit of Korean Patent Application No. 10-2017-0128284 filed on Sep. 29, 2017, the entire contents of which are incorporated herein by reference.

### BACKGROUND

This application relates to an indicator that indicates a driving or not and a heating intensity of a working coil regardless of a heating area, and an induction heating device including the same.

In homes and restaurants, the cooking utensils using various methods to heat food are being used. Conventionally, a gas range using gas as fuel has been widely supplied. However, in recent years, the devices to heat a cooking vessel such as an object to be heated, for example, such as a pot, by using electricity without using gas, have been supplied.

A method of heating an object to be heated using electricity is largely divided into a resistive heating method and an induction heating method. In the electrical resistive method, a heat, which is generated when current flows to a non-metallic heating element such as silicon carbide or a metal resistance wire, is transmitted to the object to be heated through a radiation or conduction, thereby heating the object to be heated. In the induction heating method, when a high-frequency power of a predetermined magnitude is applied to the coil, an eddy current is generated in the object to be heated (for example, the cooking vessel) made of a metal by using a magnetic field generated around the coil, so that the object to be heated itself is heated.

An induction heating device applied with the induction heating method has a working coil in a corresponding area, respectively, in order to heat each of a plurality of implementations to be heated (for example, the cooking vessel).

### SUMMARY

FIG. 1 illustrates a conventional induction heating device.

As shown in FIG. 1, an induction heating device 10 according to the related art includes a case 25 and a cover plate 20 that is coupled to an upper end of the case 25. In addition, one or more working coils 27a and 27b having a circular shape is arranged in the case 25.

Specifically, the cover plate 20 coupled with the case 25 includes a top plate portion 15 for placing an object to be heated such as a cooking vessel. Here, the top plate portion 15 may be made of a glass material.

The light emitting modules 30a and 30b having a circular shape corresponding to the shape of the working coils 27a and 27b may be arranged in an inner space formed by the case 25 and the cover plate 20.

The light emitting modules 30a and 30b may include a plurality of LEDs and may be arranged in an upper portion of the working coils 27a and 27b. Accordingly, when the working coils 27a and 27b are driven, the light emitting modules 30a and 30b have the plurality of LEDs emit a light, thereby allowing a user to confirm a driving or not and a heating intensity (that is, a heating power) of the working coils 27a and 27b through a LED light (for example, 17a and 17b) displayed in the top plate portion 15.

However, conventionally, a position of the light emitting modules 30a and 30b are fixed so as to correspond to a shape of the working coil, an area in which the LED light is illuminated depending on the size of the object to be heated, is limited. In addition, depending on an eccentricity of the object to be heated or not, a position and the size of a flame shape realized in the top plate portion 15 by LED light can be changed.

That is, in the conventional induction heating device 10, when the size of the object to be heated is larger than a predetermined heating area or the object to be heated is eccentric in a predetermined heating area, there is a problem that it is difficult for the user to confirm the driving or not and the heating intensity of the working coil. As a result, there is a limitation that the user can confirm the driving or not and the heating intensity of the working coil only in the predetermined heating area.

Further, there is a problem that a conventional method of confirming the driving or not and the heating intensity of the working coil is difficult to be applied to an induction heating device in a zone free method which has been widely supplied in recent years.

That is, in the induction heating device in the zone free method, a method that an object to be heated can be simultaneously heated by a plurality of working coils (that is, in an area in which a plurality of working coils exist, a method of induction-heating the object to be heated regardless of the size and the position of the object to be heated) is applied. When the conventional method of confirming the driving or not and the heating intensity of the working coil is applied, there is a problem that it is difficult to resolve the above-mentioned problem.

In addition, since the plurality of working coils exist in the induction heating device in the zone free method, when the conventional method of confirming the driving or not and the heating intensity of the working coil is applied, there is a problem that a control method and a circuit complexity of the light emitting module (that is, LED) are increased and a difficulty in assembling and manufacturing is also increased.

In some implementations, an indicator can indicate a driving or not and a heating intensity of the working coil regardless of the heating area and an induction heating device including the same.

In some implementations, an indicator can indicate a driving or not and a heating intensity of a working coil without a separate control circuit and an induction heating device including the same.

The implementations of this application are not limited to the above-mentioned implementations, and the other implementations and the advantages of this application, which are not mentioned, can be understood by the following description, and more clearly understood by the implementations of this application. It will be also readily seen that the implementations and the advantages of this application may be realized by means indicated in the patent claims and a combination thereof.

The indicator and the induction heating device including the same according to this application includes a magnetic flux sensing coil that senses a magnetic flux generated when the working coil is driven and converts the sensed magnetic flux into current, a rectifying portion that rectifies current converted in the magnetic flux sensing coil, and a light emitting module that receives current rectified by the rectifying portion to emit a light, so that it can indicate a driving or not and a heating intensity of the working coil regardless of a position of a heating area.

In addition, the indicator and the induction heating device including the same according to this application include a light emitting module that is automatically turned on or turned off depending on the driving or not of the working coil, and a brightness is automatically changed according to a magnitude change of the magnetic flux generated in the working coil, so that it can indicate the driving or not and the heating intensity of the working coil without a separate control circuit.

The indicator and the induction heating device including the same according to this application can indicate the driving or not and the heating intensity of the working coil regardless of the heating area. Accordingly, the user can easily confirm the driving or not and the heating intensity of the working coil regardless of the size of the object to be heated and an eccentricity or not of the object to be heated, so that a convenience of use can be improved.

In addition, the indicator and the induction heating device including the same according to this application can indicate the driving or not and the heating intensity of the working coil without the separate control circuit. Accordingly, even when a plurality of working coils are arranged, there is no need to worry about an increase in the difficulty in assembly and manufacturing due to an increase in a complexity of the control circuit, so that a burden of the user can be reduced.

In general, one innovative aspect of the subject matter described in this specification can be implemented in an indicator for an induction heating device including a working coil, the indicator comprising: a magnetic flux sensing coil that is configured to (i) sense magnetic flux generated in a state in which the working coil is driven and (ii) convert the sensed magnetic flux into current; a rectifying portion that is configured to rectify current converted by the magnetic flux sensing coil; and a light emitting module that is configured to emit light based on current rectified by the rectifying portion.

The foregoing and other implementations can each optionally include one or more of the following features, alone or in combination. In particular, one implementation includes all the following features in combination. The indicator further comprises: a substrate, wherein the magnetic flux sensing coil, the rectifying portion, and the light emitting module are mounted on a surface of the substrate. Based on the working coil being driven and magnetic flux being generated by the working coil, the light emitting module is turned on. Based on driving of the working coil being stopped, the light emitting module is turned off. A brightness of the light emitting module changes based on a magnitude of magnetic flux generated by the working coil. The brightness of the light emitting module increases as the magnitude of magnetic flux generated by the working coil increases. The brightness of the light emitting module decreases as the magnitude of the magnetic flux generated by the working coil decreases. The light emitting module comprises one or more Light Emitting Diode (LED) elements.

In general, another innovative aspect of the subject matter described in this specification can be implemented in an induction heating device comprising: a working coil portion that includes a first working coil and a second working coil; a magnetic flux sensing coil, wherein a first portion of the magnetic flux sensing coil is arranged on or over the first working coil and a second portion of the magnetic flux sensing coil is arranged on or over the second working coil, the magnetic flux sensing coil being configured to (i) sense magnetic flux generated by at least one of the first working coil or the second working coil and (ii) convert the sensed magnetic flux into current; a rectifying portion that is configured to rectify current converted by the magnetic flux sensing coil; and a light emitting module that is configured to emit light based on current rectified by the rectifying portion.

The foregoing and other implementations can each optionally include one or more of the following features, alone or in combination. In particular, one implementation includes all the following features in combination. The induction heating device further includes: a case on which the working coil portion is mounted; and a cover plate (i) that is coupled to the case to cover an interior area of the case and (ii) that is configured to be in contact with an object to be heated directly. The induction heating device further includes: a substrate that is located in the interior area of the case, wherein the working coil portion, the magnetic flux sensing coil, the rectifying portion, and the light emitting module are arranged on a surface of the substrate. The induction heating device further includes: a substrate that is located in the interior area of the case, wherein (i) the working coil portion is arranged adjacent to a first surface of the substrate and (ii) the magnetic flux sensing coil, the rectifying portion, and the light emitting module are arranged adjacent to a second surface of the substrate. Based on at least one of the first working coil or the second working coil being driven and magnetic flux being generated by the at least one of the first working coil or the second working coil, the light emitting module is turned on. Based on driving of both of the first working coil and the second working coil being stopped, the light emitting module is turned off. A brightness of the light emitting module changes based on a magnitude of magnetic flux generated by the working coil portion. The brightness of the light emitting module increases as the magnitude of magnetic flux generated by the working coil portion increases. The brightness of the light emitting module decreases as the magnitude of the magnetic flux generated by the working coil portion decreases.

In general, another innovative aspect of the subject matter described in this specification can be implemented in an induction heating device comprising: a working coil portion that includes a first working coil and a second working coil; a magnetic flux sensing coil that includes: a first magnetic flux sensing coil that is arranged on or over the first working coil, that is configured to sense magnetic flux generated by the first working coil, and that is configured to convert the sensed magnetic flux into current, and a second magnetic flux sensing coil that is arranged on or over the second working coil, that is configured to sense magnetic flux generated by the second working coil, and that is configured to convert the sensed magnetic flux into current; a rectifying portion that is configured to rectify current converted by the first magnetic flux sensing coil and the second magnetic flux sensing coil; and a light emitting module that is configured to emit light based on current rectified by the rectifying portion.

The foregoing and other implementations can each optionally include one or more of the following features, alone or in combination. In particular, one implementation includes all the following features in combination. The rectifying portion includes: a first rectifying portion that is configured to rectify current converted by the first magnetic flux sensing coil, and a second rectifying portion that is configured to rectify current converted by the second magnetic flux sensing coil. The light emitting module includes: a first light emitting module that is configured to emit light based on the current rectified by the first rectifying portion, and a second light emitting module that is configured to emit light based on current rectified by the second rectifying portion.

Hereafter, a specific effect of this application, in addition to the above-mentioned effect, will be described together while describing a specific matter for implementing this application.

### BRIEF DESCRIPTION OF THE DRAWINGS

FIG. 1 is a diagram illustrating an example of a conventional induction heating device.

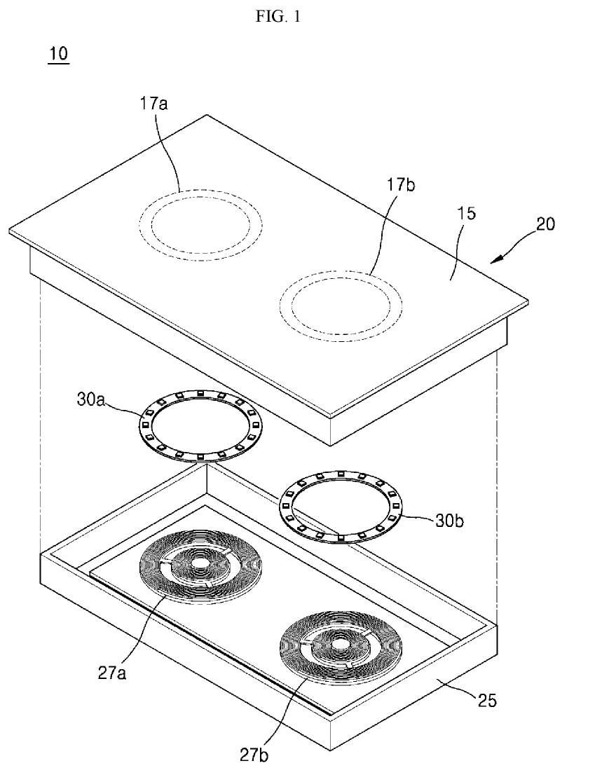

FIG. 2 is a diagram illustrating an example indicator for an induction heating device.

FIG. 3 is a diagram illustrating an example induction heating device including the indicator illustrated in FIG. 2.

FIG. 4 is a diagram illustrating first example elements of an indicator to implement the indicator of FIG. 3.

FIG. 5 is a diagram illustrating second example elements of an indicator to implement the indicator of FIG. 3.

Like reference numbers and designations in the various drawings indicate like elements.

### DETAILED DESCRIPTION

Hereinafter, an indicator in accordance with an exemplary implementation of this application will be described.

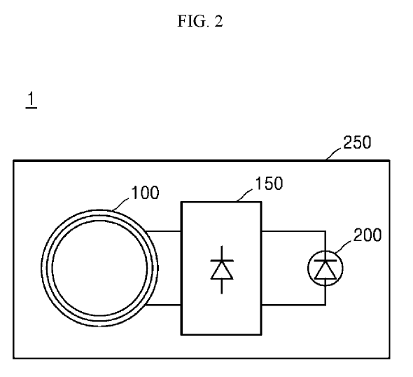

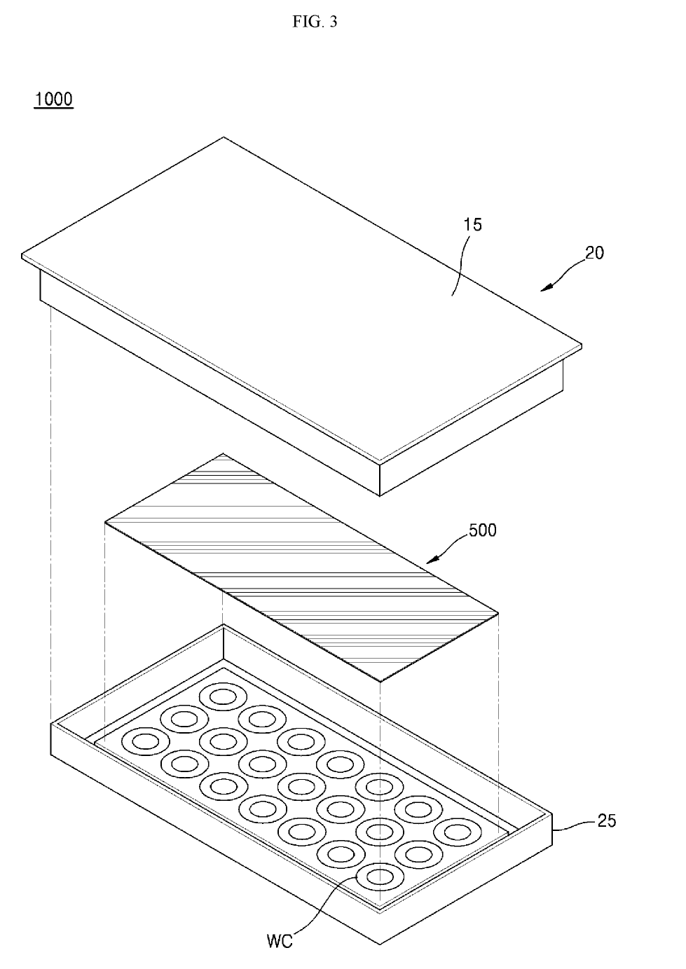

FIG. 2 illustrates an example indicator. In some implementations, an indicator 1 is driven by being associated with a working coil (WC in FIG. 3) provided in an induction heating device (1000 in FIG. 3). The working coil and the induction heating device are described in greater detail below with reference to FIG. 3.

Referring to FIG. 2, the indicator 1 in accordance with an exemplary implementation of this application may include a magnetic flux sensing coil 100, a rectifying portion 150, a light emitting module 200, and a substrate 250.

The magnetic flux sensing coil 100 senses a magnetic flux generated when a working coil is driven, and can convert the sensed magnetic flux into current.

Specifically, in the case of the working coil provided in the induction heating device, when a high-frequency power of the predetermined size is applied, a magnetic field (i.e., a magnetic flux) is generated around or near the working coil, so that the magnetic flux sensing coil 100 can sense the magnetic flux (or a change of the magnetic flux) generated by the working coil.

In addition, the magnetic flux sensing coil 100 may convert a sensed magnetic flux into current and provide it to the rectifying portion 150.

In some implementations, the magnetic flux sensing coil 100 can convert the sensed magnetic flux into an alternating current, and can be configured so that a coil is wound by two turns or more, but is not limited thereto.

The rectifying portion 150 can rectify the converted current in the magnetic flux sensing coil 100.

Specifically, the rectifying portion 150 can rectify the alternating current converted in the magnetic flux sensing coil 100 into a direct current.

In addition, the rectifying portion 150 can provide the rectified current (e.g., direct current) to the light emitting module 200.

The light emitting module 200 may receive the rectified current from the rectifying portion 150 to emit light. In some implementations, the light emitting module 200 may include one or more Light Emitting Diode (LED) elements.

That is, the rectifying portion 150 receives current sensed by the magnetic flux sensing coil 100 after the magnetic flux sensing coil 100 senses the magnetic flux generated in the working coil and converts it into current. The light emitting module 200 can be turned on or turned off based on a state of the working coil, e.g., the working coil being driven or being not driven.

Specifically, the light emitting module 200 is automatically turned on when the working coil is driven and the magnetic flux is generated, and can be automatically turned off when the driving of the working coil is stopped.

Further, a brightness of the light emitting module 200 may be varied depending on the magnitude of the current received from the rectifying portion 150.

Specifically, the magnitude of the current converted in the magnetic flux sensing coil 100 is varied according to the magnitude of the magnetic flux generated in the working coil, and the magnitude of the current supplied to the light emitting module 200 (that is, the brightness of the light emitting module 200) can be determined according to the magnitude of the current converted in the magnetic sensing coil 100.

Accordingly, the brightness of the light emitting module 200 automatically increases as the magnitude of the magnetic flux generated in the working coil increases, and automatically decreases as the magnitude of the magnetic flux generated in the working coil decreases.

That is, when the user controls a heating power (i.e., a heating intensity) through an input interface of the induction heating device, the magnitude of the magnetic flux generated in the working coil is also controlled. Thus, even if the light emitting module 200 is not separately controlled, the brightness of the light emitting module 200 can be automatically controlled. This improves the design of the induction heating devices by simplifying the control of the elements of the induction heating device.

Meanwhile, the magnetic flux sensing coil 100, the rectifying portion 150, and the light emitting module 200 may be arranged on the substrate 250.

Specifically, the substrate 250 may include, for example, a Printed Circuit Board (PCB) or a Flexible PCB (FPCB).

In addition, the substrate 250 may be designed as a modular shape type or a single plate type (i.e., a large area substrate).

Here, when the substrate 250 is designed in the modular shape type, it is possible to couple or separate the substrates 250. When the substrate 250 is designed in the single plate type, a plurality of magnetic flux sensing coils, a plurality of rectifying portions, and a plurality of light emitting modules can be arranged on a substrate 250. The specific matter thereof will be described later.

In some implementations, the substrate 250 is provided in an inner space formed by a case (25 in FIG. 3) and a cover plate (20 in FIG. 3) described later, and can be arranged on or over a working coil.

Hereinafter, the above-mentioned induction heating device including the indicator 1 of FIG. 2 will be described.

FIG. 3 illustrates an example induction heating device including the indicator illustrated in FIG. 2. Referring to FIG. 3, the induction heating device 1000 may include a case 25, a cover plate 20, a plurality of working coils WC, and an indicator 500.

In some implementations, for convenience of explanation, in the implementation of this application, it is described on the assumption that the induction heating device 1000 is an induction heating device in a zone free method. Of course, the induction heating device 1000 may be an induction heating device in another method other than the zone free method.

Specifically, the plurality of working coils WC may be provided in the case 25.

In some implementations, in addition to the plurality of working coils WC, the case 25 may be arranged with various devices related to a driving the working coil (for example, a power supply that provides an alternating power, a rectifying portion that rectifies the alternating power of the power supply to a direct current, an inverter portion that converts the direct current power rectified by the rectifying portion into a resonance current through a switching operation to provide it to a working coil, a control portion that controls an operation of various devices in the induction heating device 1000, a relay or a semiconductor switch that turns on or turns off the working coil), but a specific description thereof will be omitted.

The cover plate 20 is coupled to an upper end of the case 25, and an object to be heated can be arranged on an upper surface.

Specifically, the cover plate 20 may include a top plate portion 15 for placing the object to be heated such as a cooking vessel.

Here, the top plate portion 15 may be made of, for example, a glass material and the top plate portion 15 may be provided with an input interface that receives an input from a user and transmit it to the control portion, but is not limited thereto.

That is, an input interface may be provided at a position other than the top plate portion 15.

The indicator 500 is provided between the case 25 and the cover plate 20 and can be arranged on or over an upper portion of the working coil WC.

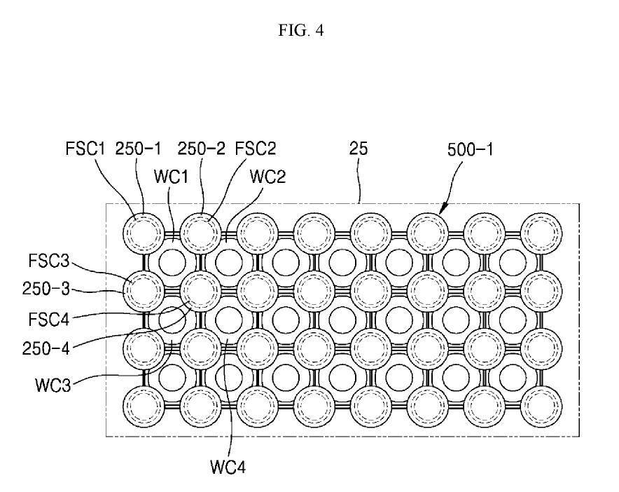

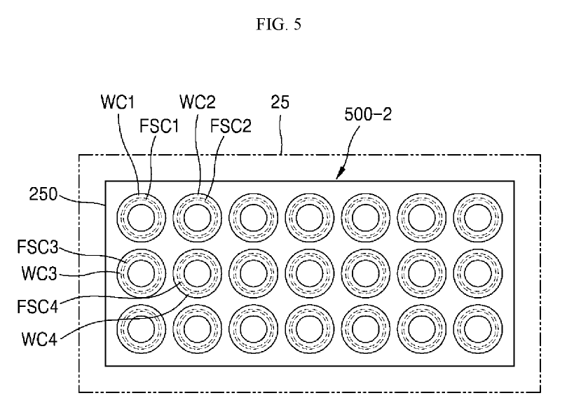

In some implementations, the indicator 500 may include the same component (i.e., a magnetic flux sensing coil, a rectifying portion, a light emitting module) as that of the indicator 1 shown in FIG. 2, and each component may be made in plurality. Further, the indicator 500 may include a substrate designed as a modular shape type or a single plate type, as mentioned above, and the specific matter thereof will be described in FIGS. 4 and 5.

FIG. 4 illustrates first example elements of an indicator to implement the indicator illustrated in FIG. 3. Referring to FIG. 4, an indicator 500-1 including a substrate designed in a modular shape type (for example, 250-1 to 250-4) is shown.

Specifically, when the substrate is designed in the modular shape type, a magnetic flux sensing coil (for example, FSC1 to FSC4), a rectifying portion, and a light emitting module may be separately arranged on each of the substrates (for example, 250-1 to 250-4), and each of the substrates (for example, 250-1 to 250-4) can be coupled to or separated from each other.

That is, a first magnetic flux sensing coil FSC1, a first rectifying portion, and a first light emitting module may be arranged on a first substrate 250-1, and a second magnetic flux sensing coil FSC2, a second rectifying portion, and a second light emitting module may be arranged on a second substrate 250-2. In addition, a third magnetic flux sensing coil FSC3, a third rectifying portion and a third light emitting module may be arranged on a third substrate 250-3, and a fourth magnetic flux sensing coil FSC4, a fourth rectifying portion, and a fourth light emitting module can be arranged on a fourth substrate 250-4.

In some implementations, for convenience of explanation, the rectifying portion and the light emitting module are not separately shown in the drawings.

In some implementations, as shown in the drawing, each of the substrates (for example, 250-1 to 250-4) may be formed in a matrix form or a honeycomb form such that a portion of an area overlaps with each working coil (for example, WC1 to WC4).

Accordingly, it is possible to sense a magnetic flux of the working coil through the magnetic flux sensing coil arranged on each substrate regardless of a heating area (that is, regardless of a position of the working coil), and it is possible indicate a driving or not and a heating intensity of the working coil through the light emitting module arranged on each substrate based on a sensed magnetic flux.

For example, it is possible to sense the magnetic flux of the first working coil WC1 through the first magnetic flux sensing coil FSC1 arranged on the first substrate 250-1 and it is possible to indicate a driving or not and a heating intensity of the first working coil WC1 through the first light emitting module arranged on the first substrate 250-1 based on the sensed magnetic flux.

In addition, when the second substrate 250-2 is arranged on or over the first and second working coils WC1 and WC2, the second magnetic flux sensing coil FSC2 arranged on the second substrate 250-2 can sense a magnetic flux generated when driving at least one of the first and second working coils WC1 and WC2.

Accordingly, the second light emitting module arranged on the second substrate 250-2 can be turned on when at least one of the first and second working coils WC1 and WC2 is driven to generate the magnetic flux, and can be turned off when the driving of both first and second working coils WC1 and WC2 is stopped. In addition, the brightness of the second light emitting module arranged on the second substrate 250-2 can be increased and decreased based on the magnitude of at least one of the magnetic flux generated in the first and second working coils WC1 and WC2 (that is, the first and second working coils WC1 and WC2).

That is, a driving or not and a heating intensity of a plurality of working coils provided in an induction heating device in a zone free method can be easily indicated through the indicator 500-1 including a modular shape type substrate (for example, 250-1 to 250-4) arranged in the honeycomb form (or the matrix form).

FIG. 5 illustrates second example elements of an indicator to implement the indicator illustrated in FIG. 3. Referring to FIG. 5, an indicator 500-2 that includes a substrate 250 that is designed in a single plate type is shown.

Specifically, when the substrate 250 is designed in a single plate type, a plurality of magnetic flux sensing coils (for example, FSC1 to FSC4), a plurality of rectifying portions, and a plurality of light emitting modules can be arranged, in pair, on a substrate 250, respectively. That is, on the substrate 250, the plurality of magnetic flux sensing coils are arranged with a predetermined distance and two adjacent magnetic flux sensing coils can be separated from each other. For example, the magnetic flux sensing coils can be arranged on or over the respective working coils such that one magnetic flux sensing coil can be arranged on or over one corresponding working coil. In some implementations, a rectifying portion and a light emitting module can be arranged for each magnetic flux sensing coil.

For example, when a first magnetic flux sensing coil FSC1 is arranged on a first working coil WC1, a first rectifying portion and a first light emitting module are arranged to be connected to a first magnetic flux sensing coil FSC1. When a second magnetic flux sensing coil FSC2 is arranged on a second working coil WC2, the second rectifying portion and the light emitting module can be arranged to be connected to a second magnetic flux sensing coil FXC2. In addition, the third magnetic flux sensing coil FSC3 is arranged on a third working coil WC3, a third rectifying portion and a third light emitting module are arranged to be connected to a third magnetic flux sensing coil FSC3. When a fourth magnetic flux sensing coil FSC4 is arranged on a fourth working coil WC4, a fourth rectifying portion and a fourth light emitting module can be arranged to be connected to a fourth magnetic flux sensing coil FSC4.

In some implementations, for convenience of explanation, the rectifying portion and the light emitting module are not separately shown in the drawings.

Accordingly, even when the substrate 250 is designed in the single plate type, it is possible to sense a magnetic flux of each working coil through the plurality of magnetic flux sensing coils arranged in the substrate 250 regardless of a heating area (that is, regardless of a position of the working coil), and it is possible to indicate a driving or not and a heating intensity of the working coil through the plurality of light emitting modules arranged in the substrate 250 based on a sensed magnetic flux.

For example, it is possible to sense a magnetic flux of the first working coil WC1 based on the first magnetic flux sensing coil FSC1, and indicate a driving or not and a heating intensity of the first working coil WC1 through the first light emitting module connected to the first magnetic flux sensing coil FSC1 based on a sensed magnetic flux.

That is, a driving or not and a heating intensity of a plurality of working coils provided in the induction heating device in a zone free method can be easily indicated through the indicator 500-2 including a single plate type substrate 250.

Although not shown in the drawings, each magnetic flux sensing coil (for example, FSC1 to FSC4) may be arranged in a matrix form or a honeycomb form on the substrate 250 so that a portion of an area is overlapped with each of the working coils WC1 to WC4.

As mentioned above, the indicator and the induction heating device including the same according to this application can indicate the driving or not and the heating intensity of the working coil regardless of the heating area. Accordingly, the user can easily confirm the driving or not and the heating intensity of the working coil regardless of the size of an object to be heated or an eccentricity or not of the object to be heated, so that a convenience of use can be improved.

In addition, the indicator and the induction heating device including the same in accordance with an exemplary implementation of this application can indicate the driving or not and the heating intensity of the working coil without a separate control circuit. Accordingly, even when the plurality of working coils are arranged, there is no need to worry about a difficulty in assembly and manufacturing due to an increase in a complexity of the control circuit for the user, so that the burden of the user can be reduced.

Since various substitutions, changes, and modifications can be made within the scope that does not deviate the technical idea of this application for those skilled in the art to which this application pertains, the above-mentioned application is not limited by the above-mentioned implementations and the accompanying drawings.

What is claimed is:

1. An indicator for an induction heating device including a working coil, the indicator comprising:
a magnetic flux sensing coil that is configured to (i) sense magnetic flux generated in a state in which the working coil is driven and (ii) convert the sensed magnetic flux into current;
a rectifying portion that is configured to rectify current converted by the magnetic flux sensing coil; and
a light emitting module that is configured to emit light based on current rectified by the rectifying portion.

2. The indicator of claim 1, further comprising:
a substrate, wherein the magnetic flux sensing coil, the rectifying portion, and the light emitting module are mounted on a surface of the substrate.

3. The indicator of claim 1, wherein, based on the working coil being driven and magnetic flux being generated by the working coil, the light emitting module is turned on.

4. The indicator of claim 1, wherein, based on driving of the working coil being stopped, the light emitting module is turned off.

5. The indicator of claim 1, wherein a brightness of the light emitting module changes based on a magnitude of magnetic flux generated by the working coil.

6. The indicator of claim 5, wherein, the brightness of the light emitting module increases as the magnitude of magnetic flux generated by the working coil increases.

7. The indicator of claim 5, wherein the brightness of the light emitting module decreases as the magnitude of the magnetic flux generated by the working coil decreases.

8. The indicator of claim 1, wherein the light emitting module comprises one or more Light Emitting Diode (LED) elements.

9. An induction heating device comprising:
a working coil portion that includes a first working coil and a second working coil;
a magnetic flux sensing coil, wherein a first portion of the magnetic flux sensing coil is arranged on or over the first working coil and a second portion of the magnetic flux sensing coil is arranged on or over the second working coil, the magnetic flux sensing coil being configured to (i) sense magnetic flux generated by at least one of the first working coil or the second working coil and (ii) convert the sensed magnetic flux into current;
a rectifying portion that is configured to rectify current converted by the magnetic flux sensing coil; and
a light emitting module that is configured to emit light based on current rectified by the rectifying portion.

10. The induction heating device of claim 9, further comprising:
a case on which the working coil portion is mounted; and
a cover plate (i) that is coupled to the case to cover an interior area of the case and (ii) that is configured to be in contact with an object to be heated directly.

11. The induction heating device of claim 10, further comprising:
a substrate that is located in the interior area of the case, wherein the working coil portion, the magnetic flux sensing coil, the rectifying portion, and the light emitting module are arranged on a surface of the substrate.

12. The induction heating device of claim 10, further comprising:
a substrate that is located in the interior area of the case, wherein (i) the working coil portion is arranged adjacent to a first surface of the substrate and (ii) the magnetic flux sensing coil, the rectifying portion, and the light emitting module are arranged adjacent to a second surface of the substrate.

13. The induction heating device of claim 9,
wherein, based on at least one of the first working coil or the second working coil being driven and magnetic flux being generated by the at least one of the first working coil or the second working coil, the light emitting module is turned on.

14. The induction heating device of claim 9,
wherein, based on driving of both of the first working coil and the second working coil being stopped, the light emitting module is turned off.

15. The induction heating device of claim 9, wherein a brightness of the light emitting module changes based on a magnitude of magnetic flux generated by the working coil portion.

16. The induction heating device of claim 15, wherein the brightness of the light emitting module increases as the magnitude of magnetic flux generated by the working coil portion increases.

17. The induction heating device of claim 15, wherein the brightness of the light emitting module decreases as the magnitude of the magnetic flux generated by the working coil portion decreases.

18. An induction heating device comprising:
a working coil portion that includes a first working coil and a second working coil;
a magnetic flux sensing coil that includes:
a first magnetic flux sensing coil that is arranged on or over the first working coil, that is configured to sense magnetic flux generated by the first working coil, and that is configured to convert the sensed magnetic flux into current, and
a second magnetic flux sensing coil that is arranged on or over the second working coil, that is configured to sense magnetic flux generated by the second working coil, and that is configured to convert the sensed magnetic flux into current;
a rectifying portion that is configured to rectify current converted by the first magnetic flux sensing coil and the second magnetic flux sensing coil; and
a light emitting module that is configured to emit light based on current rectified by the rectifying portion.

19. The induction heating device of claim 18, wherein the rectifying portion includes:
a first rectifying portion that is configured to rectify current converted by the first magnetic flux sensing coil, and
a second rectifying portion that is configured to rectify current converted by the second magnetic flux sensing coil.

20. The induction heating device of claim 19, wherein the light emitting module includes:
a first light emitting module that is configured to emit light based on the current rectified by the first rectifying portion, and
a second light emitting module that is configured to emit light based on current rectified by the second rectifying portion.
